(19) United States
(12) Patent Application Publication
(10) Pub. No.: US 2013/0083445 A1
(43) Pub. Date: Apr. 4, 2013

(54) ION GENERATOR

(71) Applicant: Tetsuhide OKAHASHI, Osaka (JP)

(72) Inventor: Tetsuhide OKAHASHI, Osaka (JP)

(21) Appl. No.: 13/586,920

(22) Filed: Aug. 16, 2012

(30) Foreign Application Priority Data
Sep. 29, 2011 (JP) 2011-213657

(51) Int. Cl. H01T 23/00

(52) U.S. Cl. 361/230

(57) ABSTRACT

An ion generator 100 of the present invention includes a charging section 103, a transformer 104, an ion generating element 105, a switching element 108, and a drive section 107 for controlling the switching element 108 to be turned on or off. The switching element 108 is (i) turned on after completion of electric charge by the charging section 103 and (ii) turned off during a time period between T/4 and T/2, where T is a resonant cycle which is determined by inductance of a secondary coil 104b of the transformer 104 and capacitance of the ion generating element 105.

This Nonprovisional application claims priority under 35 U.S.C. §119 on Patent Application No. 2011-213657 filed in Japan on Sep. 29, 2011, the entire contents of which are hereby incorporated by reference.

### TECHNICAL FIELD

The present invention relates to an ion generator, and especially to an ion generator that (i) can be operated with a direct current power supply such as a battery and (ii) uses little electric power and is therefore capable of operating for an extended period of time.

### BACKGROUND ART

An ion generator has been used for a wide variety of devices such as stationary air ionizers, stationary air conditioners/regulators, and the like. Since these devices are stationary models and thus typically use commercial alternating currents as power supplies, ion generators to be used for these devices inevitably use commercial alternating currents as power supplies as well.

In recent years, however, there has been an increasing amount of demands for portable air ionizers. A portable air ionizer requires a direct current power supply such as a battery, and thus addresses a need for a reduction in battery power consumption in order to maintain an operation for relatively long hours. In order to meet such a need, various technologies have been suggested.

FIG. 4 is a circuit diagram illustrating main components of an ion generator 10 disclosed in Patent Literature 1. The ion generator 10 includes a battery 16, a switch 11, a switching-pulse signal generating section 17, an FET 18, and a transformer 14. The switching-pulse signal generating section 17 includes a square wave oscillator circuit 12, a high-frequency passing filter 19, and a schmitt-trigger inverter 13. Also, an ion generating element (not illustrated) is provided on the far side of the transformer 14.

The following description will discuss a basic operation of the ion generator 10, which operation ultimately creates, across a secondary coil of the transformer 14, a high voltage for inducing ion generation.

When the switch 11 is closed (turned on), the square wave oscillator circuit 12 in the switching-pulse signal generating section 17 generates a square wave that determines cycles of a switching-pulse signal. The high-frequency passing filter 19 collects an edge wave out of the square wave, and the edge wave is reinforced by the schmitt-trigger inverter 13 so as to be then supplied, as a switching-pulse signal, to the FET 18.

The FET 18 receives the switching-pulse signal, and then switches between “on” and “off” of voltage supply from the battery 16 to a primary coil of the transformer 14, depending on the pulse widths and the pulse intervals of the switching-pulse signal. Then, by the effect of an electromagnetic induction principle, a voltage, which has been converted from a voltage of the switching-pulse signal, is generated across the secondary coil of the transformer 14.

By using an edge wave collected out of a square wave generated by the square wave oscillator circuit 12, the switching-pulse signal is generated such that the pulse width of the signal is shorter than the pulse interval of the signal. This allows (i) a frequency of ion generation to be regulated and therefore (ii) consumption of the battery 16 to be reduced.

### CITATION LIST

### Patent Literature

### Patent Literature 1

Japanese Patent Application Publication, Tokukai, No. 2006-179363 A (Publication Date: Jul. 6, 2006)

### SUMMARY OF INVENTION

### Technical Problem

A device disclosed in Patent Literature 1 is designed to obtain the following specific amounts of ions at a distance of 20 cm away from an edge of an ion generating electrode: (i) 10,000 particles/cm³ or more but not more than 100,000 particles/cm³ in order to allow ion generation to be continued for a week or more with use of two AAA batteries and (ii) 50,000 particles/cm³ or less from the perspective of downsizing of the device. In an attempt to achieve such amounts of ion generation, the device is designed to generate a high voltage for ion generation by directly converting, with the transformer, a voltage of a switching-pulse signal. This, since the voltage prior to the conversion is low, unfortunately puts limitations on the conversion of a discharge voltage for ion generation, which conversion is achieved by increasing a transformation ratio (i.e. turns ratio) of the transformer.

In addition, although Patent Literature 1 claims to have been able to extend a period of continual operation of the device by reducing battery consumption, the amount of ion generation is correspondingly low. This poses such a problem that the device is incapable of carrying out effective operation in a case where a user is away from the ion generator by a certain distance. The problem is also caused by the facts that the ion generator disclosed in Patent Literature 1 is designed to be used right beside a user, and that enlargement of the device as a result of enlargement of the transformer is unacceptable due to the need for portability.

Furthermore, there also exists the following problem. In light of its use on a desk, the ion generator is required to (i) generate approximately the foregoing amounts of ions while a user is away from the ion generator by 60 to 80 cm and (ii) be able to cover, in order to obtain variations in the amount of ion generation, a wide range of ion generation frequencies. Unfortunately, the device is capable of neither of such operations.

The present invention has been made in view of the problems, and it is an object of the present invention to provide an ion generator capable of generating a large amount of ions while achieving low energy consumption.

### Solution to Problem

An ion generator of the present invention includes: a charging section which is charged by a supplied DC voltage; a transformer having a primary coil and a secondary coil, an output voltage of the charging section being applied across the primary coil, and a damping oscillation voltage being outputted from the secondary coil; an ion generating element to which the damping oscillation voltage is applied; a switching element provided between the primary coil and ground; and a drive section for controlling the switching element to be turned on or off, the switching element being (i) turned on after completion of electric charge by the charging section and (ii) turned off during a time period corresponding to a period between T/4 and T/2, where T is a resonant cycle which is determined by inductance of the secondary coil and capacitance of the ion generating element.

An ion generator of the present invention includes: a charging section which is charged by a supplied DC voltage; a transformer having a primary coil and a secondary coil, an output voltage of the charging section being applied across the primary coil, and a damping oscillation voltage being generated across the secondary coil; an ion generating element to which the damping oscillation voltage is applied; a switching element for switching between on and off states of application of the output voltage of the charging section to the primary coil; and a drive section for controlling the switching element to be turned on or off, the switching element being (i) turned on after completion of electric charge by the charging section and (ii) turned off during a time period between T/4 and T/2, where T is a resonant cycle which is determined by inductance of the secondary coil and capacitance of the ion generating element.

### Advantageous Effects of Invention

With an ion generator of the present invention, it is possible to produce a sufficient amount of ions without unnecessary power consumption while electric current is supplied to a transformer.

### BRIEF DESCRIPTION OF DRAWINGS

FIG. 1 is a block diagram illustrating an ion generator 100 in accordance with Embodiment 1 of the present invention.

FIG. 2 is a graph illustrating a relationship, in the ion generator 100 in accordance with Embodiment 1, between (i) an output voltage of a transformer 104 and (ii) on and off states of an FET 108.

FIG. 3 is a graph illustrating a charging characteristic of a charging section 103.

FIG. 4 is a circuit diagram illustrating a conventional ion generator 10.

### DESCRIPTION OF EMBODIMENTS

### Embodiment 1

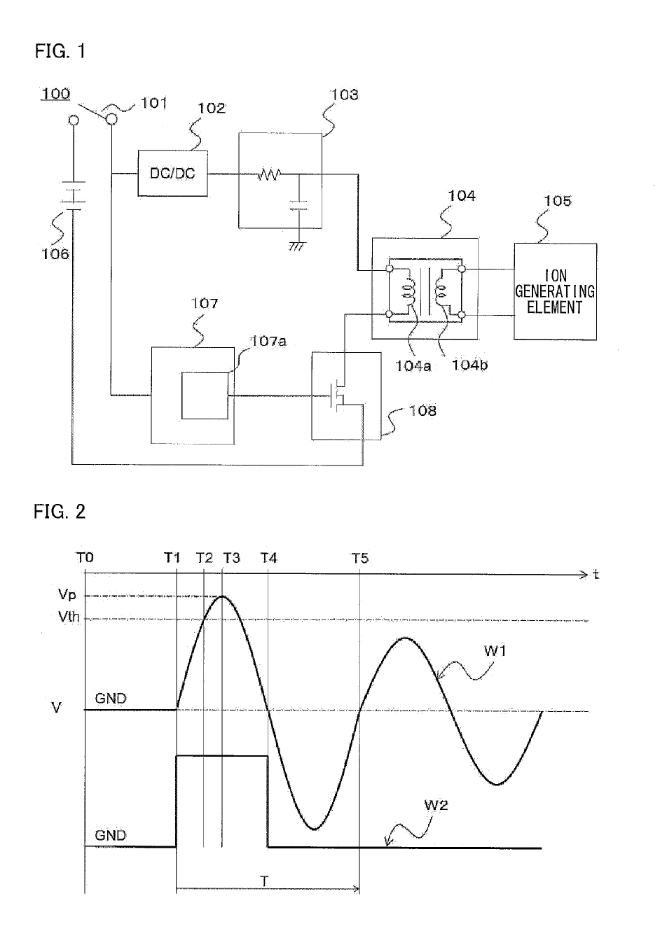

The following is a description of Embodiment 1 of the present invention with reference to FIGS. 1 and 2. FIG. 1 is a block diagram illustrating an ion generator 100 in accordance with Embodiment 1. FIG. 2 is a graph illustrating a relationship, in the ion generator 100, between (i) an output voltage of a secondary coil of a transformer 104 and (ii) on and off states of an FET 108.

First, a configuration of the ion generator 100 will be discussed below with reference to FIG. 1. The ion generator 100 includes (i) a switch 101, (ii) a DC-to-DC converter 102 whose input terminal is connected to one terminal of the switch 101, (iii) a charging section 103 whose input terminal is connected to an output terminal of the DC-to-DC converter 102, (iv) a transformer 104 in which one of input terminals of its primary coil is connected to an output terminal of the charging section 103, (v) an ion generating element 105 which is connected to a secondary coil of the transformer 104, (vi) an FET (Field-Effective Transistor) 108 whose output terminal is connected to the other terminal of the primary coil side of the transformer 104, and (vii) a drive section 107 provided between an input terminal of the FET 108 and the switch 101.

A direct current power supply such as a battery 106 is connected to the other terminal of the switch 101. It is possible to use, as a battery 106, a dry battery or a rechargeable battery. It is also possible to use, without using a battery, a commercial alternating power supply (not illustrated) by replacing the switch 101 with a dipolar switch and by connecting a separate AC adapter to one pole of the dipolar switch and connecting the other pole to the battery 106.

Note that it is possible to increase the amplitude of a damping oscillation voltage generated across the transformer 104, by employing an FET 108 whose on-state resistance is low. This allows an increase in the amount of ion generation. Also note that the charging section 103 is an integrating circuit including a resistor and a capacitor. The resistor functions also as a limiting resistor for preventing a drastic flow of an electric current to the capacitor.

The ion generating element 105 includes (i) a needle electrode for electrical discharge and (ii) an induction electrode facing against the needle electrode. It is preferable to use a needle electrode, in view of an increase in the amount of ion generation as well as a reduction in the amount of ozone generation.

The following description will discuss how the ion generator 100 operates, with reference to FIG. 1. A voltage is supplied from the battery 106 to the DC-to-DC converter 102, via the switch 101. Such a voltage is converted by the DC-to-DC converter 102, for example, from 3 V (generated by two 1.5V AAA batteries connected in series) to 20 V. This allows the transformer 104 (step-up transformer) to have a reduced transformation ratio (step-up ratio). 20 V thus converted is supplied to the charging section 103. In the charging section 103, predetermined electric charges are stored.

The voltage is also supplied from the battery 106 to the drive section 107, via the switch 101. The FET 108 is turned on by drive section 107 at a timing when electric charges stored by the charging section 103 reach the predetermined electric charges after the switch 101 is closed (turned on). Note that an “on” state of the FET 108 is a state in which there is a continuity across a drain and a source of the FET 108 in response to a forward bias voltage applied to a gate of the FET 108. In contrast, an “off” state of the FET 108 is a state in which there is no continuity across a drain and a source of the FET 108 because no forward bias voltage is applied to the gate of the FET 108. Also note that what is meant by “the timing at which the electric charges stored by the charging section 103 reach the predetermined electric charges” is the time at which, after the switch 101 is closed, the charging section 103 completes a charging operation.

When the FET 108 is turned on at a timing at which electric charges stored by the charging section 103 reach the predetermined electric charges, the electric charges stored by the capacitor of the charging section 103 are discharged. During the discharging, the electric current corresponding to the stored electric charges flows to ground, via a primary coil 104a of the transformer 104, the drain of the FET 108, and the source of the FET 108 in this order. A damping oscillation voltage is generated in accordance with a ratio between the number of turns of the primary coil 104a and the number of turns of the secondary coil 104b. Then, the damping oscillation voltage is applied to the ion generating element 105. Ion is generated in response to discharging of an electrode in the ion generating element 105. Immediately after this, the FET 108 is turned off by the drive section 107. Note that a relationship between charge/discharge of the charging section 103 and the control of the FET 108 by the drive section 107 will be discussed later with reference to FIG. 2.

After the FET 108 is turned off by the drive section 107, a series of identical operations will be repeated: the charging by the charging section 103, the turn-on of the FET 108, the generating of a damping oscillation voltage by the secondary coil 104b of the transformer 104, and the ion generation by the ion generating element 105.

Note that it is possible to use, as a drive section 107, (i) a CPU (Central Processing Unit) including a timer 107a or (ii) an IC (Integrated Circuit) including a timer 107a. This allows (i) timings of “on” time and “off” time of the FET 108 and (ii) a cycle on which the FET 108 is turned on, to be regulated.

By employing a CPU as a drive section 107, it is made possible to carry out variable control with respect to “on” time and “off” time of the FET 108 (i.e. durations of “on” time and a cycle on which the FET 108 is turned on), independently of each other. In other words, it is possible to carry out variable control, in a wide range, with respect to (i) the amount of ion to be generated and (ii) the frequency of ion generation.

The following description will discuss, with reference to FIGS. 1 and 2, how the turn-on and the turn-off of the FET 108 are controlled by the drive section 107. FIG. 2 is a graph illustrating a relationship between (i) a waveform W1 representing a damping oscillation voltage generated by the secondary coil 104a of the transformer 104 and (ii) a waveform W2 representing the turn-on and the turn-off of the FET 108. Note that, in FIG. 2, the horizontal axis represents time t, and the vertical axis represents voltage V.

According to FIG. 2, after the switch 101 shown in FIG. 1 is closed at time T0, the FET 108 is turned on by the drive section 107 (a positive voltage with respect to GND) at time T1 at which the charging is completed by the charging section 103. Note that a time length between time T0 and time T1 (a time period required for a charging voltage to rise from 10% to 90%) is, for example, 2.2 times as long as a time constant of the charging section 103.

When the FET 108 is turned on, the waveform W1 of a damping oscillation voltage (i) rises at time T1, (ii) reaches, at time T2, a voltage Vth which causes the ion generating element 105 to start electrical discharge, (iii) reaches a peak voltage Vp at time T3, (iv) falls and reaches a voltage having a polarity reversed to a polarity during the rising, and (v) oscillates with sinusoidal waves which alternates between rising and falling, and (vi) progressively attenuates (damps).

Meanwhile, the FET 108 is driven so as to be, after being turned on at time T1, (i) kept in the on-state at least until the waveform W1 reaches the voltage Vth at time T2 at which the ion generating element 105 begins electrical discharge and then (ii) turned off by the drive section 107 at or before time T4. Although FIG. 2 shows that the FET 108 is turned off at time T4, Embodiment 1 is not limited to this. Alternatively, the FET 108 can be turned off at anywhere between time T2 and time T4.

Note here that, the waveform W1 has a cycle T after the switch 101 is closed, and the cycle T is equal to the reciprocal of a resonant frequency determined by inductance of the secondary coil 104b and internal capacitance of the ion generating element 105 (not illustrated). Specifically, the cycle T is equal to the time length from time T1 to time T5, and therefore its half cycle is equal to the time length from time T1 to time T4.

Based on the factors, the following description will discuss a concrete example of how the drive section 107 regulates the time at which the FET 108 is turned off. A resonant frequency, which is determined by the inductance of the secondary coil 104b and the internal capacitance of the ion generating element 105, is set to, for instance, 200 kHz, which is sufficiently higher than the audible frequency. In this case, a cycle T is 5 μs. Therefore, a time length of the waveform W1 from time T1 to time T5 is 5 μs as well. Also, a time length from time T1 to time T4 is half of the time length from time T1 to time T5, and is therefore 2.5 μs. Note that the resonant frequency is (i) set to a frequency sufficiently higher than the audible frequency in order to prevent noises that would be otherwise made whenever a damping oscillation voltage is generated and (ii) not particularly limited to 200 kHz.

In view of the circumstances, time T4, which is the latest time point by which the FET 108 is to be turned off, is set to the point 2.5 μs after time T1, which is half of the cycle T. In theory, the earliest time at which the FET 108 is to be turned off can be set to time T2 at which the waveform W1 has a voltage equal to the voltage Vth that is the electric discharge voltage of the ion generating element 105. In reality, however, the time, at which the FET 108 is to be turned off, is set, to be on the safe side, to time T3 at which the waveform W1 has the peak voltage Vp, in view of a desired amount of ion to be generated. Specifically, the time, at which the FET 108 is to be turned off, is set to 1.25 μs. This is based on the fact that, in the case where a cycle of the waveform W1 is equal to T, a time length between time T1 and time T3 is equal to T/4.

In summary, the FET 108 is controlled by the drive section 107 to, after the switch 101 is turned on, (i) be turned on at time T1 at which the electric charge is completed in the charging section 103 and then (ii) be turned off during a period of time between time T3 and time T4, that is, a period between 1.25 μs and 2.5 μs after time T1.

In Embodiment 1, electric current is supplied to the transformer 104 (see FIG. 1), for each time when the FET 108 is turned on, for an extremely short time period of “on” time (i.e. a time period between T/4 and T/2). This causes suppression of power consumption caused by supplying the electric current to the transformer 104. This ultimately allows (i) a reduction in power consumption of the battery 106 and therefore (ii) the ion generator 100 to operate for an extended period of time. Note that FIG. 2 illustrates the waveform W1 of on/off of the FET 108 which corresponds to a waveform of a single “on” period. Embodiment 1 μs, however, not limited to this. Alternatively, it is possible that the drive section 107 controls the FET 108 to be turned on in accordance with a desired amount of ion to be generated/a desired frequency of ion generation. The drive section 107 controls the FET 108 to be turned on, for example, 60 times per second.

As described above, according to Embodiment 1, the FET 108 is, in the case where a cycle of the waveform W1 is equal to T, turned off by the drive section 107 within the time period between T/4 and T/2. That is, the ion generator 100 is set, in order to obtain an electric discharge voltage necessary for ion generation, to supply electric current to the transformer 104 for an extremely short time period of time each time. This allows (i) a reduction in power consumption of the battery 106 and therefore (ii) the ion generator 100 to operate for an extended period of time. In addition, since electric current is supplied to the transformer 104, for each time when the FET 108 is turned on, for an extremely short time period, it is possible to set a discharge voltage to a relatively high voltage. This allows an increase in the amount of ion to be generated.

### Embodiment 2

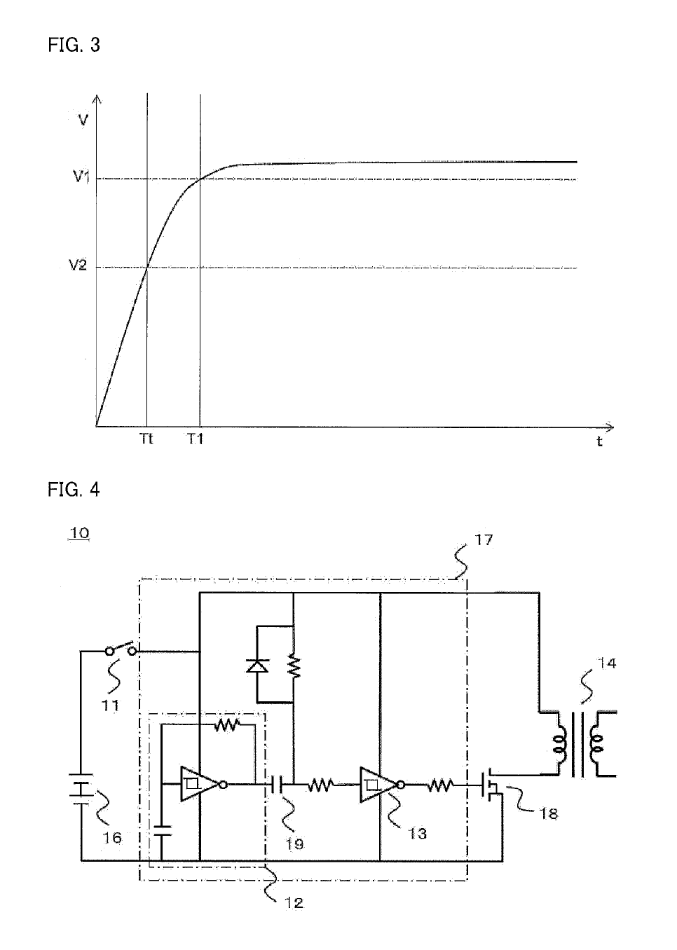

Embodiment 2 will be discussed below with reference to FIG. 3. FIG. 3 illustrates a charging characteristic of a charging section 103 shown in FIG. 1.

In Embodiment 1, time T1, at which the FET 108 is turned on, is set, by the control of the drive section 107, to the time at which the charging voltage by the charging section 103 reaches the charging voltage V1, by which the capacitor is almost fully charged. Specifically, it takes 2.2 times as much time as the time constant of the charging section 103 for the charging voltage to reach the charging voltage V1. Note that Embodiment 2 differs from Embodiment 1 in that the FET 108 is turned on while electric charge in the charging section 103 is still in a transient state.

Specifically, the time, at which the FET 108 is turned on, is set, by the control of the drive section 107, to the time equivalent to a time constant Tt of the charging section 103 (see FIG. 3). In this case, a charging voltage V2 is approximately 63% of a voltage supplied to the charging section 103. Specifically, if the voltage supplied to the charging section 103 is 20 V, then a voltage of approximately 12 V is supplied to a primary coil 104a of a transformer 104.

According to Embodiment 1, if the transformer 104 has a transformation ratio of 200, then the charging section 103 outputs a voltage of approximately 20 V in a case where the FET 108 is turned on at time T1 by the control of the drive section 107. This causes a damping oscillation voltage of approximately 4 kV to be generated across the secondary coil 104b of the transformer 104.

According to Embodiment 2, on the other hand, a damping oscillation voltage of approximately 2.4 V is generated across a secondary coil 104b of the transformer 104, if a voltage supplied to the primary coil 104a of the transformer 104 (that is, a voltage charged by the charging section 103) is approximately 12 V. In short, a voltage applied to the ion generating element 105 becomes less than that of Embodiment 1. This means that a voltage Vth, at which the ion generating element 105 starts electrical discharge, is lowered. In other words, it is made possible to use an ion generating element whose voltage Vth, at which to start electrical discharge, is low. As such, it is possible to reduce (i) a voltage across the transformer 104 and therefore (ii) overall power consumption. This makes it possible to further extend operation hours of an ion generator 100, while maintaining a sufficient amount of ion to be generated.

Embodiments 1 and 2 and the concrete examples, which have been discussed in the detailed description, are illustrative only, which should not be narrowly interpreted within the limits of such Embodiments and concrete examples, but are rather meant to be applied in any variations within the spirit of the present invention, provided that such variations do not exceed the scope of the patent claims set forth below.

The ion generator of Embodiment 1 of the present invention is preferably configured such that the switching element is turned on at time at which a charging voltage by the charging section reaches a voltage at which the ion generating element starts electrical discharge.

The ion generator of Embodiment 2 of the present invention is preferably configured such that the switching element is turned on when elapsed time, which starts from a beginning of electric charge by the charging section, reaches a time constant of the charging section.

### INDUSTRIAL APPLICABILITY

The present invention is widely applicable to ion generators or apparatuses in general which employ the respective ion generators.

### REFERENCE SIGNS LIST

100 Ion generator
101 Switch
102 DC-to-DC converter
103 Charging section
104 Transformer (voltage boosting section)
104a Primary coil
104b Secondary coil
105 Ion generating element
106 Battery
107 Drive section
107a Timer
108 FET (switching element)

1. An ion generator comprising:
a charging section which is charged by a supplied DC voltage;
a transformer having a primary coil and a secondary coil, an output voltage of the charging section being applied across the primary coil, and a damping oscillation voltage being outputted from the secondary coil;
an ion generating element to which the damping oscillation voltage is applied;
a switching element provided between the primary coil and ground; and
a drive section for controlling the switching element to be turned on or off,
the switching element being (i) turned on after completion of electric charge by the charging section and (ii) turned off during a time period corresponding to a period between T/4 and T/2, where T is a resonant cycle which is determined by inductance the secondary coil and capacitance of the ion generating element.

2. An ion generator comprising:
a charging section which is charged by a supplied DC voltage;
a transformer having a primary coil and a secondary coil, an output voltage of the charging section being applied across the primary coil, and a damping oscillation voltage being generated across the secondary coil;
an ion generating element to which the damping oscillation voltage is applied;
a switching element for switching between on and off states of the application of the output voltage of the charging section to the primary coil; and
a drive section for controlling the switching element to be turned on or off,
the switching element being (i) turned on after completion of electric charge by the charging section and (ii) turned off during a time period between T/4 and T/2, where T is a resonant cycle which is determined by inductance of the secondary coil and capacitance of the ion generating element.

3. The ion generator as set forth in claim 1, wherein the switching element is turned on at time at which a charging voltage by the charging section reaches a voltage at which the ion generating element starts electrical discharge.

4. The ion generator as set forth in claim 2, wherein the switching element is turned on at time at which a charging voltage by the charging section reaches a voltage at which the ion generating element starts electrical discharge.

5. The ion generator as set forth in claim 1, wherein the switching element is turned on when elapsed time, which starts from a beginning of electric charge by the charging section, reaches a time constant of the charging section.

6. The ion generator as set forth in claim 2, wherein the switching element is turned on when elapsed time, which starts from a beginning of electric charge by the charging section, reaches a time constant of the charging section.
